(19) United States
(12) Patent Application Publication
(10) Pub. No.: US 2026/0067956 A1
(43) Pub. Date: Mar. 5, 2026

(54) SYSTEMS AND METHODS FOR SELECTING VIRTUAL CHANNELS FOR WIRELESS COMMUNICATION

(71) Applicant: The Chamberlain Group LLC, Oak Brook, IL (US)

(72) Inventor: Edward Bandyk, Woodridge, IL (US)

(21) Appl. No.: 18/825,492

(22) Filed: Sep. 5, 2024

(51) Int. Cl. H04W 76/14

(52) U.S. Cl. CPC H04W 76/14

(57) ABSTRACT

A method for communicating over a wireless network. The method includes detecting, by a first device, a trigger event triggering communication with a second device and determining a desired channel of a plurality of communication channels appropriate for communication with a second device based on the trigger event. The method further includes generating, by the first device, an advertisement including a desired channel byte corresponding to the desired channel. The method further includes receiving, by the second device, the advertisement and identifying the desired channel byte included in the advertisement. The method further includes, transmitting, by the second device, a connection request for establishing a communication connection with the first device via the desired channel and associated connection parameters in response to identifying the desired channel byte included in the advertisement.

### BACKGROUND

In traditional bidirectional wireless communication systems, a single communication channel is utilized by two communicating devices for all communication purposes, which can include communicating informational data bidirectionally, and can also include communicating commands from a controlling device to a controlled device. Accordingly, if the bidirectional communication between two devices includes a combination of controlling commands and informational data, the commands and informational data are treated equally and are communicated over the single communication channel in the order in which they occur. That is, a command may be held in a queue by a transmitting device until the two devices have finished a prior communication sequence for communicating informational data, and vice versa.

### SUMMARY

The disclosed examples are described in detail below with reference to the accompanying drawing figures listed below. The following summary is provided to illustrate some examples disclosed herein.

Example solutions include systems and associated methods for selecting and establishing wireless communication connection via a virtual communication channel of a plurality of virtual communication channels. One such exemplary method includes, by a first device, a trigger event triggering communication with a second device and determining a desired channel of a plurality of communication channels appropriate for communication with a second device based on the trigger event. The method further includes generating, by the first device, an advertisement including a desired channel byte corresponding to the desired channel. The method further includes receiving, by the second device, the advertisement and identifying the desired channel byte included in the advertisement. The method further includes, transmitting, by the second device, a connection request for establishing a communication connection with the first device via the desired channel indicated by the desired channel byte in response to identifying the desired channel byte included in the advertisement.

### BRIEF DESCRIPTION OF THE DRAWINGS

The disclosed examples are described in detail below with reference to the accompanying drawing figures listed below:

FIG. 1 illustrates a movable barrier system, according to an example of this disclosure;

FIG. 2 is a block diagram illustrating an example of a user-operated control device of the system of FIG. 1;

FIG. 3 is a block diagram illustrating an example of a movable barrier operator of the system of FIG. 1;

FIG. 4 is a diagram illustrating advertisements transmitted by a user-operated control device of the system of FIG. 1;

FIG. 5 is a diagram illustrating advertisements transmitted by a movable barrier operator of the system of FIG. 1;

FIGS. 6-8 are diagrams illustrating establishing wireless connections on different virtual channels; and

FIG. 9 is a flowchart illustrating a process for establishing wireless connections on virtual channels.

Corresponding reference characters indicate corresponding parts throughout the drawings.

### DETAILED DESCRIPTION

In traditional bidirectional wireless communication systems, a single communication channel is utilized by two communicating devices for all communication purposes, which can include communicating informational data bidirectionally, and can also include communicating commands from a controlling device to a controlled device. Accordingly, if the bidirectional communication between two devices includes a combination of controlling commands and informational data, the commands and informational data are treated equally and are communicated over the single communication channel in the order in which they occur.

In remote-controlled movable barrier systems, however, certain communications between a control device and a movable barrier operator need to be processed and acted upon by the operator as soon as possible to provide the desired user experience where control device activations are met with responsive corresponding actions. For example, if a user activates their control device to open a movable barrier, the user expects the opening of the movable barrier to occur nearly-instantaneously with the activation of the control device. Using various traditional methods in which communication between the control device and operator utilizes a single communication channel, the control device may ultimately have to wait to transmit the actuation command to the operator if the control device and operator are already engaged in a prior communication sequence on the single channel which, of course, provides for undesirable results related to responsiveness and the user's expectations.

As will be discussed in greater detail below, example solutions of this disclosure provide for a bidirectional wireless communication system where the control device and operator are able to form communication connections with each other over a plurality of virtual communication channels such that operational commands are prioritized and delivered efficiently and quickly from the control device to the operator.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

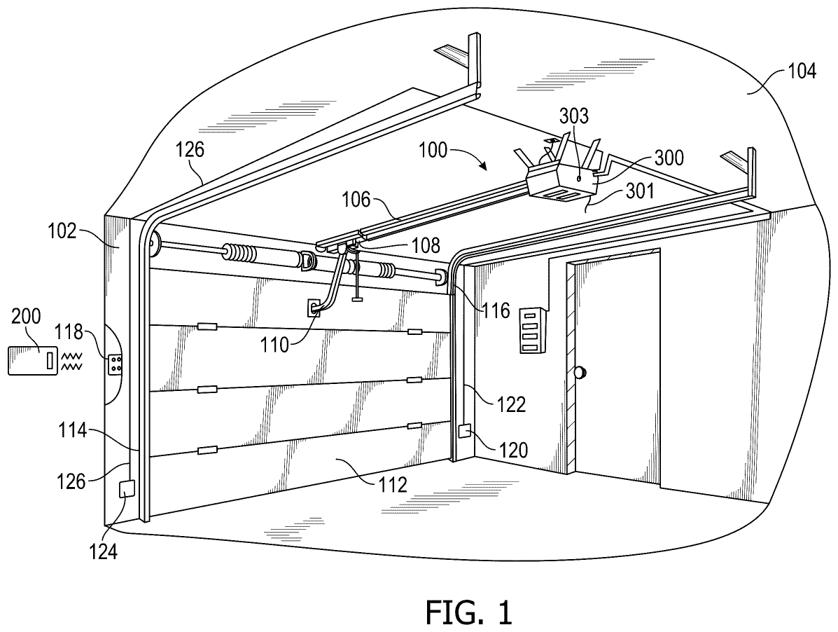

FIG. 1 illustrates a movable barrier operator system 100 that includes a movable barrier operator 300 and a control device 200. As shown, according to some examples, system 100 is utilized in a garage 102 setting. Control device 200 can comprise any of various known control devices, such as, for example, a handheld device such as a remote control, a wall-mounted control device, a control device integral to a vehicle, or the like. In the illustrated example, operator 300 is mounted to the ceiling 104 of the garage 102 and includes a rail 106 extending therefrom with a releasable trolley 108 attached having an arm 110 extending to a barrier 112 positioned for movement along a pair of door tracks 114, 116. In this example depicting a garage 102 setting, barrier 112 comprises a garage door. Control device 200 is adapted to send signals to and receive signals from the operator 300. An antenna 301 may be positioned on the operator 300 and coupled to a receiver as discussed hereinafter in order to receive transmissions from the control device 200. An external control pad 118 may also be positioned on the outside of the garage 102 and include a user interface thereon for receiving user commands that are communicated via radio frequency transmission with the antenna 301 of the operator 300. In some examples, the external control pad 118 is accessible from an outside location and in some examples constitutes a control device 200. An optical emitter 120 may be connected via a power and signal line 122 to the operator 300 with an optical detector 124 connected via a wire 126 to the operator 300 in order to prevent closing of the barrier 112 on a person or object inadvertently in the door's path. An input such as a button or switch 303 may be provided for switching the operator 300 between modes, such as operating mode and learn mode. FIG. 1 depicts an illustrative example of a movable barrier system according to one example of this disclosure in a garage environment, and those with skill in the art will recognize that various other movable barrier examples in various other settings fall within the scope of this disclosure. For example, other movable barrier environments of this disclosure include environments such as over-head doors used for bays, room dividers, gates, and any other movable barrier controlling or providing access to an area.

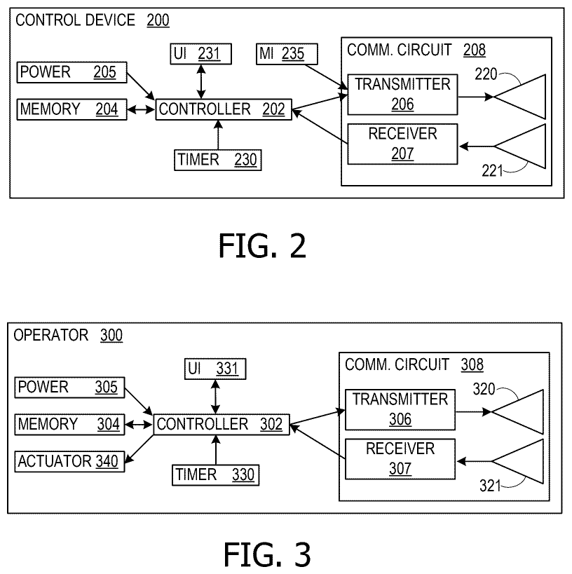

FIG. 2 illustrates a block diagram of the control device 200. Control device 200 includes a communication circuit 208 comprising both a transmitter 206 and receiver 207 (which may be combined into a single transceiver mechanism) in operative communication with antennas 220 and 221, respectively. The antennas can be positioned in, on, or extending from the control device 200, wherein the transmitter 206 and receiver 207 are configured for wirelessly transmitting and receiving transmission signals to and from the operator 300, including transmission signals that contain a first rolling access code with a fixed code portion and a rolling code portion. In some embodiments, both the transmitter and receiver may communicate with a single antenna or multiple antennas, and in some examples the transmitter and receiver may be configured to be a single transceiver device in communication with a single antenna. Control device 200 also includes a controller 202 in operative communication with the transmitter 206 and a memory 204 and is configured for processing data and carrying out commands. The memory 204 may be, for instance, a non-transitory computer readable medium, and may have stored thereon instructions that when executed by a controller circuit cause the controller circuit to perform operations. A power source 205 is coupled to the controller 202 and/or other components, and may be routed in some embodiments so that a user interface (UI), such as UI 231, couples/decouples the power source to other components so that power is supplied only upon activation of the UI 231 or a specified time thereafter. Controller 202 is configured to generate the transmission signal with a signal identifier and cause the transmitter 206 to transmit the signal, and the receiver 207 is configured to receive responsive transmissions from one or more operators 300. Optionally, a timer 230 in communication with the controller 202 enables the controller 202 to determine the time of incoming and outgoing signal transmissions and provides reference for the controller 202 to enable and disable the transmitter 206 and/or receiver 207 of the device. In some embodiments, a manual setting interface (MI) 235 may be provided, which in some forms may include one or more dual in-line package (DIP) switches or other devices configured to allow a user to configure a setting or state of the controller 202. MI 235 may be operatively coupled to the transmitter 206 in order to allow for signal transmissions including information regarding the current setting or state of the manual setting interface. Memory 204 is connected for operative communication with controller 202 and is configured to store data such as codes and, in some examples, other information for outgoing transmissions. Memory 204 is further configured to store fixed and/or changing or variable code information for comparison to incoming transmissions.

UI 231 may include one or more user-operable switches for inputting commands to the control device 200, for example to issue a barrier movement command or a learning command. UI 231 may be associated with a button, lever, or other device to be actuated, for example by a user's hand or other actions, events, or conditions. As other examples, the UI 231 may be voice operated or operated by a user contacting a touch-sensitive screen as the location of an object displayed on the screen. The UI 231 may include multiple buttons, levers, switches, displays, microphone(s), speaker(s), or other inputs associated with different tasks, or operations, to be carried out by the operator 300. As one example, the UI 231 includes a plurality of mechanical buttons that each operate a respective switch. As another example, UI 231 includes a display with one or more virtual buttons.

FIG. 3 illustrates a block diagram of operator 300. According to various examples, the operator 300 includes a controller 302 in communication with a memory 304 and is configured for storing and retrieving data to and from the memory 304 as well as processing data and carrying out commands. A power source 305, such as an AC power conduit, battery, or other type of power source, supplies electricity to the controller 302 to allow operation. As an example, power source 305 may include an AC power conduit, a power conditioning circuit, a battery, and/or a battery charging circuit. Operator 300 also includes a communication circuit 308 comprising a wireless transmitter 306 and receiver 307 (or combination transceiver device) in operative communication with the controller 302. As shown, transmitter 306 communicates with a first antenna 320 and receiver 307 communicates with a second antenna 321, but both devices may communicate with a single antenna or multiple antennas, and in some embodiments the device may be configured to have a single transceiver device in communication with a single antenna. The antennas may be positioned in, on, or extending from the operator 300. In this regard, signals, such as radio frequency or other wireless transmission carriers, may be sent to and received from the control device 200 according to a variety of frequencies or modulations. Signals may be modulated in a number of different ways; thus, the control device 200 and movable barrier operator 300 may be configured to communicate with one another via a variety of techniques. Controller 302 of the operator 300 is also in communication with an actuator such as an actuator 340 in order to carry out an operation such as moving a barrier, which may include for example lifting or lowering a bay or a garage door; sliding, swinging, or rotating a gate; or otherwise moving or repositioning a barrier structure. Actuator 340 can comprise any actuating device for moving the associated movable barrier, such as, for example, a motor, a pneumatic or hydraulic actuator, a linear motion actuator, a rotary actuator, or the like.

User Interface (UI) 331, which includes one or more input devices such as buttons, keys or a touch-screen interface, for example, receives user input to override the controller 302 or place the controller in and out of a learning mode in which the operator 300 may be paired with a user-operated device, such as control device 200, by exchanging and storing messages.

The term controller refers broadly to any microcontroller, application specific integrated circuit (ASIC), field programmable gate array (FPGA), computer, state machine, or processor-based device with processor, memory, and programmable input/output peripherals, which is generally designed to govern the operation of other components and devices. It is further understood to include common accompanying accessory devices. The controller can be implemented through one or more processors, microprocessors, central processing units, logic, local digital storage, firmware, software, and/or other control hardware and/or software and may be used to execute or assist in executing the steps of the processes, methods, functionality, and techniques described herein. Furthermore, in some implementations the controller may provide multiprocessor functionality. These architectural options are well known and understood in the art and require no further description here. The controllers may be configured (for example, by using corresponding programming stored in a memory as will be well understood by those skilled in the art) to carry out one or more of the steps, actions, and/or functions described herein.

When a user actuates UI 231 of the control device 200, such as by pressing a button designated as performing a particular action, the controller 202 activates the transmitter 206 to transmit through antenna 220 a message based on information stored in the memory 204. The message is received by the receiver 307 of operator 300 and communicated to the operator's controller 302. In some embodiments, the controller 302 verifies the message by comparing the message to stored information from the operator's memory module 304, and upon verification the controller 302 is configured to cause transmission of a response signal from the transmitter 306 through antenna 320. If the message from the user-actuated control device 200 includes information relating to timing parameters for a response, the operator's controller 302 receives time information from a timer 330 in order to determine when to transmit the response in order to comply with timing parameters of the control device 200.

The control device 200 may be configured to verify that the response from the operator 300 complies with transmitted timing requirements in any number of ways. In some embodiments, controller 202 may compare a time stamp or other timing information relating to the operator's response to the transmitted time parameter using timer 230. In some embodiments, receiver 207 is generally inactive, but switched on by controller 202 only for a short time period consistent with the transmitted timing parameter. For instance, controller 202 may switch on receiver 207 for a window of time matching a time window transmitted in an outgoing message through transmitter 206, and upon expiration of the time window according to timer 230, controller 202 switches receiver 207 off again. Timing information may be either relative, for instance a specified number of seconds, milliseconds, or nanoseconds after transmission of an outgoing signal or other event, or may be absolute such as standard date and time information for a specific time zone. A timing synchronization protocol may be provided in some forms in order to maintain precision of timing with other devices despite drift or other factors.

As discussed, communication circuits 208, 308 can comprise two-way communication circuits configured to both transmit and receive communications signals. In some examples, communication circuits 208, 308 comprise short-range wireless communication modules, such as Bluetooth or Bluetooth low energy (BLE) modules or circuits, for example. As such, as those with skill in the art will understand, all wireless communication connections referred to herein utilized by operators 300 and control devices 200 can be any known short-range wireless communication connections, such as Bluetooth or BLE connections, for example.

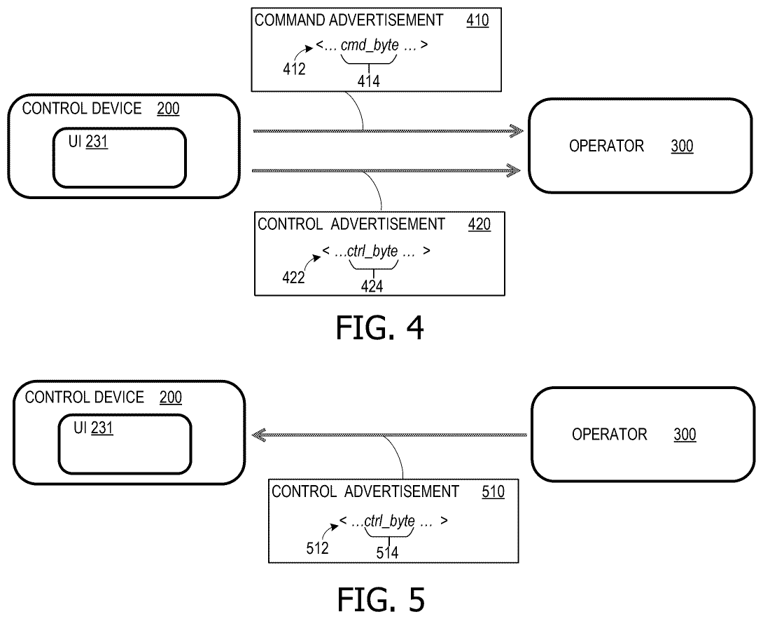

FIG. 4 is a diagram illustrating various advertisements 410, 420 that can be transmitted by control device 200 and received by operator 300. Herein, control device 200 can be referred to as an “advertising device,” as control device 200 sends advertisements for connection to connecting devices, as will be discussed in greater detail below. Additionally, operator 300 can be referred to herein as a “connecting device” because it is a device that request connection with the device sending the advertising signal. As will be recognized by those with skill in the art, control devices herein can also be referred to as peripheral devices that transmit advertisements and operators herein can be referred to as central devices that receive the advertisement and request connection in response, according to terminologies commonly used in BLE and similar two-way communication connection environments. However, according to various examples, operator 300 is an advertising device and control device 200 is a connecting device, as will be discussed in greater detail below.

Control device 200 is configured to generate different advertisements 410, 420 based on the type of data being transferred to operator 300. For example, as shown, advertisement 410 is a “command” advertisement used for establishing communication via a “command” channel, while advertising signal 420 is a “control” advertisement for establishing communication via a “control” channel. The command channel can be utilized by operator 300 to communicate actuation operational commands for controlling barrier 112. For example, in response to a user activating UI 231 to open or close movable barrier, controller 202 determines that an actuation command needs to be communicated to operator 300 to actuate actuator 340 accordingly, and that this actuation operational command needs to be communicated via the command channel. Accordingly, controller 202 generates command advertisement 410 for communicating via the actuation operational command to operator 300 via the command channel. As will be discussed in greater detail below, the command channel is defined by and operates at a short connection interval to ensure that the actuation operational command is promptly delivered to operator 300 so that the command can be acted upon in a nearly instantaneous fashion by operator 300.

Command advertisement 410, generated by controller 202, includes a protocol data unit (PDU) 412 which, as those with skill in the art will understand, is comprised of various protocol, control, and device data. One such piece of data is information related to a desired channel on which controller 202 determines to establish communication for communicating a given piece of information, i.e., the command channel or the control channel. As shown, the PDU 412 of command advertisement 410 includes a command byte 414 indicating that communication is desired over the command channel. As will be discussed in greater detail below, upon receiving command advertisement 410, operator controller 302 is configured to identify the command byte 414 and proceed in establishing communication with control device 200 via the command channel in response.

According to various examples, as will be covered in greater detail below, the control channel can be utilized by control device 200 to communicate data not directly related to actuation operational commands for controlling movable barrier 112. Said another way, in some examples, the command channel is utilized for communicating actuation operation command, while the control channel is utilized for communicating other auxiliary data that does not comprise explicit actuation operation commands. As non-limiting example, the control channel can be used for communicating various pieces of information between the control device 200 and operator 300, such as cycle counts, battery life, commands turning on/off operator 300, and various other data or commands not related to actuation commands for the operation of movable barrier 112. Controller 202 generates control advertisement 420 for communicating this various data to operator 300 via the control channel. As will be discussed in greater detail below, the control channel is defined by and operates at a connection interval longer than the command channel connection interval. Because the information communicated via the control channel is not crucial to actuation operations, it can be communicated at a longer connection interval.

Control advertisement 420, generated by controller 202, includes a PDU 422 which, as those with skill in the art will understand, is comprised of various protocol, control, and device data. One such piece of data is information related to a desired channel on which the controller 202 determines to establish communication for communicating a given piece of information, i.e., the command channel or the control channel. As shown, the PDU 422 of control advertisement 420 includes a control byte 424 indicating that communication is desired over the control channel. As will be discussed in greater detail below, upon receiving control advertisement 420, operator controller 302 is configured to identify the control byte 424 and proceed in establishing communication with control device 200 via the control channel in response.

As will be discussed in greater detail below, the command channel and control channel can be referred to as virtual channels that are defined as a function of their associated connection interval. That is, the command and control channels are not defined by a physical attribute such as frequency. In various examples, where communication is established via BLE, any of the thirty-seven available BLE channels used for communication can be utilized for hosting the virtual command and control channels.

As shown in FIG. 5, communication via the control channel can also be initiated by operator 300 by transmitting its own control advertisement 510. Controller 302 is configured to generate advertisements 510 with PDU 512 including a control byte 514 indicating that communication is desired over the control channel and transmits advertisement 510 via communication circuit 508. Upon receiving control advertisement 510 via communication circuit 208, control device controller 202 is configured to identify the control byte 514 and proceed in establishing communication with operator 300 via the control channel in response. Accordingly, while operator 300 is largely referred to herein as a connecting or central device, those with skill in the art will recognize that, according to various examples of this disclosure, operator 300 can be an advertising or peripheral device. That is, communication via the control channel is bidirectional in that each of the control device 200 and the operator 300 can establish communication on the control channel via control advertisements 420, 510.

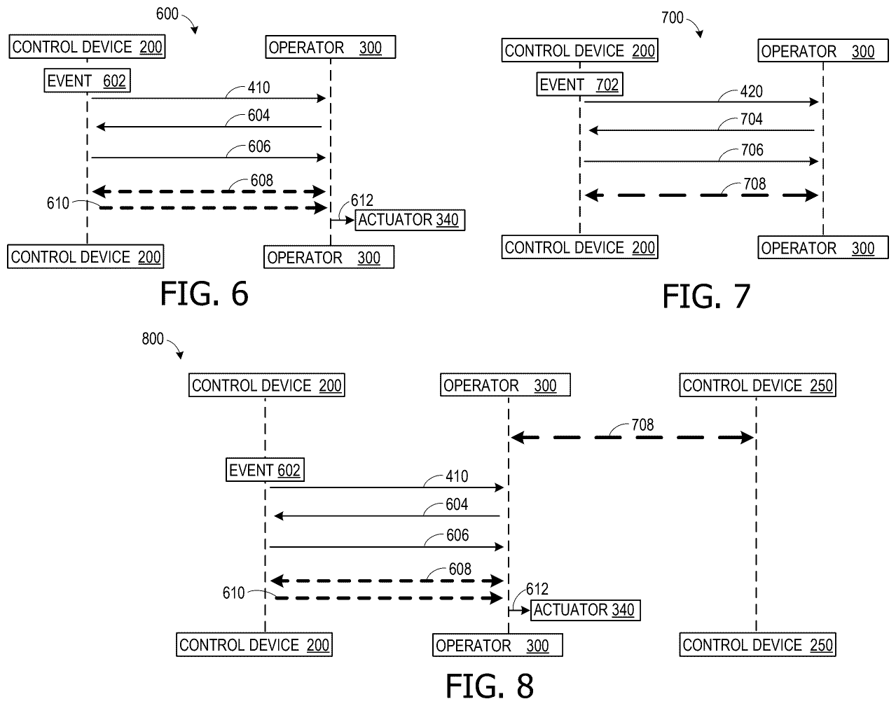

FIG. 6 is a diagram illustrating an operation 600 for establishing communication between the control device 200 and the operator 300 via the command channel. The operation begins with controller 202 detecting a trigger event 602 occurring at the control device 200 triggering communication with operator 300 via the command channel. As previously discussed, in some examples, the command channel is utilized for communicating actuation operation commands. In some examples, trigger event 602 is UI 231 being activated by a user to open/close or otherwise actuate barrier 112. In response to recognizing the trigger event 602 as relating to the actuation of barrier 112, controller 202 generates command advertisement 410 for establishing communication with operator 300 via the command channel. Controller 202 generates PDU 412 including the command byte 414. Controller 202 then transmits command advertisement 410 via communication circuit 208, and command advertisement 410 is received by operator 300 via communication circuit 308.

Operator controller 302 analyzes PDU 412 and identifies that PDU 412 includes command byte 414. In response to identifying the command byte 414, controller 302 generates a connection request 604 for requesting connection with control device 200 via the command channel. In some examples, connection request 604 can include information related to the command channel, such as identifying a connection interval associated with the command channel. Connection request 604 can also include which of the thirty-seven BLE channels is to be utilized by control device 200 and operator 300 in establishing connection via the command channel. Controller 302 then transmits connection request 604 via communication circuit 308, and connection request 604 is received by control device 200 via communication circuit 208.

Control device 200 controller 202 analyses connection request 604 and, in response, generates connection response 606. Controller 202 transmits connection response 606 via communication circuit 208, and connection response 606 is received by operator 300 via communication circuit 308. Thereby a wireless connection is established between control device 200 and operator 300 via command channel 608. Once connection is established via command channel 608, controller 202 transmits the actuation command 610 associated with trigger event 602. For example, trigger event 602 can be activation of UI 231 to open/close barrier, and thus actuation command 610 can command operator 300 to open/close barrier 112 pursuant with the activation of UI 231. Upon receiving actuation command 610, controller 302 controls 612 actuator 340 according to actuation command 610. For example, controller 302 can control 612 actuator 340 to open or close barrier 112 based on the actuation command 610. In some examples, control device 200 or operator 300 terminates the connection via command channel 608 after transmitting actuation command 610.

As mentioned, command channel 608 is defined by the connection interval associated with the channel. A connection interval is the time between two data transfer events between the control device 200 and the operator 300 after connection is established. For BLE communication, connection intervals can vary greatly, and can include intervals anywhere from approximately 7.5 millisecond to approximately 4 seconds. Command channel 608 has a relatively short connection interval, and in some examples has a connection interval of 10 milliseconds. Thus, the short connection interval of command channel 608 allows for quick communication between control device 200 and operator 300, thereby enabling a nearly instantaneous reaction in controlling 612 actuator 340 in performing actuation command 610. Those with skill in the art will recognize the connection interval of command channel 608 can be greater or less than 10 milliseconds without departing from the scope of this disclosure. Because the connection interval for the command channel 608 is so short, the connection lasts for a very short period of time. According to some examples, the connection via command channel 608 lasts approximately 400 milliseconds, although those with skill in the art will recognize that connection via command channel 608 can last more or less than 400 milliseconds without departing from the scope of this disclosure.

FIG. 7. is a diagram illustrating an operation 700 for establishing communication between the control device 200 and the operator 300 via the control channel. The operation begins with controller 202 detecting a trigger event 702 occurring at the control device 200 triggering communication with operator 300 via the control channel. As previously discussed, in some examples, the control channel is utilized for auxiliary data and commands not associated with commands for actuating barrier 112. In some examples, trigger event 702 is a scheduled or maintenance related communication. For example, controller 202 may be programmed to periodically provide information to operator related to a status of control device 200, such as battery power level, cycle count, proximity, and various other auxiliary data, and such scheduled communications can constitute trigger event 702. In some examples, controller may be programmed to periodically request information related to operator 300 from operator 300 and such scheduled requests can constitute trigger event 702. For example, controller 202 may be programmed to periodically request information from operator 300 related to a status of operator 300, such as power level, cycle count, and various other auxiliary data. In some examples, trigger event 702 can constitute an activation of UI 231 corresponding with a command unrelated to actuation of barrier 112. For example, a user may activate a button of UI 231 to power-on or power-off operator 300, and such an activation, or a similar non-actuation related command activation, would constitute trigger event 702. In some examples, control device 200 is a wall-mounted device and UI 231 includes a display to allow a user to access peruse through various menus related to the status or operation of movable barrier system 100. As such, in this example, trigger event 702 can include the user activating UI 231 to access information about system 100, including information related to operator 300. In response to recognizing the trigger event 702 as relating to an auxiliary command or auxiliary data not related to the actuation of barrier 112, controller 202 generates control advertisement 420 for establishing communication with operator 300 via the control channel. Controller 202 generates PDU 422 including the control byte 424. Controller 202 then transmits control advertisement 420 via communication circuit 208, and control advertisement 420 is received by operator 300 via communication circuit 308.

Operator controller 302 analyzes PDU 422 and identifies that PDU 422 includes control byte 424. In response to identifying the control byte 424, controller 302 generates a connection request 704 for requesting connection with control device 200 via the control channel. In some examples, connection request 704 can include information related to the control channel, such as identifying a connection interval associated with the control channel. Connection request 704 can also include which of the 37 BLE channels is to be utilized by control device 200 and operator 300 in establishing connection on the control channel. Controller 302 then transmits connection request 704 via communication circuit 308, and connection request 704 is received by control device 200 via communication circuit 208.

Control device controller 202 analyses connection request 704 and, in response, generates connection response 706. Controller 202 transmits connection response 706 via communication circuit 208, and connection response 706 is received by operator 300 via communication circuit 308. Thereby a wireless connection is established between control device 200 and operator 300 via control channel 708. Once connection is established via control channel 708, controller 202 transmits the auxiliary command, data, or request associated with trigger event 702 to operator 300 via control channel 708 and operator 300 acts according, including, when appropriate, responding to control device 200 via control channel 708.

As mentioned, control channel 708 is defined by the connection interval associated with the channel. As previously discussed, command channel 608 has a relatively short connection interval and in some examples has a connection interval of 10 milliseconds. Comparatively, control channel 708 has a longer connection interval than the relatively short connection interval of command channel 608. In some examples, the control channel 708 utilizes a connection interval of 150 milliseconds. Thus, the comparatively longer connection interval of control channel 708 allows the auxiliary data communicated via control channel 708 to be communicated slower than the fast communication enabled by command channel 608. Those with skill in the art will recognize the connection interval of control channel 708 can be greater or less than 150 milliseconds without departing from the scope of this disclosure. Because the information transferred via control channel 708 is not related to the actuation of barrier 112, the information is transferred at a longer connection interval, and the overall connection time can be much longer than the connection time of the command channel 608. According to some examples, the connection time on control channel 708 can be programed to operator 300 and control device 200 to timeout and 10 seconds, but can be extended by either control device 200 or operator 300 depending on the application. Those with skill in the art will recognize that the connection via control channel 708 can be set to timeout at greater or less than 10 seconds without departing from the scope of this disclosure.

Although FIG. 7 illustrates control device 200 as the advertising device and operator 300 as the connecting device, those with skill in the art will understand how, according to various examples, operator 300 is the advertising device for establishing connection via the control channel 708 and control device 200 is the connecting device. For example, referring additionally to FIG. 5, operator 300 can detect a triggering event (substantially the same as trigger event 702) and generate and transmit control advertisement 510. Control device 200 receives advertisement 510, identifies control byte 514, and sends a connection request (substantially the same as connection request 704) for connection via the control channel. Operator 300 receives the connection request and transmits connection response (substantially the same as connection response 706) to control device 200, thereby establishing connection with control device 200 via the control channel 708.

Utilizing multiple channels, such as the command channel 608 and the control channel 708, for communicating different types of commands and data has various advantages. For example, the quick communication between control device 200 and operator 300 on the command channel 608 ensures the actuation operation commands are quickly communicated and acted upon to ensure the user is provided with nearly instantaneous feedback in response to activating control device 200. Further, spending a limited amount of time on the command channel 608 provides for a “get in and get out” approach where the bulk of the BLE radio's capacity is utilized for as little time as possible in providing actuation operational commands so that the control channel 708 can be utilized for relaying other auxiliary data. Another advantage is that, according to some examples, command channel 608 and control channel 708 can be subject to different security protocols. For example, command channel 608 can be a secure channel subject to an encrypted security protocol while control channel 708 can be an open channel that is left open for relaying other information not subject to the security protocol. This way, operator 300 and control device 200 can communicate freely and bidirectionally via control channel 708 for relaying the various information discussed herein, but must undergo a security protocol authorization process before communicating with each other via command channel 608.

FIG. 8 is a diagram illustrating an operation 800 for establishing communication between the control device 200 and the operator 300 via command channel 608 simultaneous with operator 300 being connected via control channel 708 with another control device 250. Control device 250 is substantially the same as control device 200. As shown, control device 250 and operator 300 are engaged in communication via control channel 708 according to operation 700 previously described. While communicating via control channel 708, controller 202 of control device 200 can detect trigger event for actuating barrier 112, such as trigger event 602 previously discussed. From this, operation 600 (including transmissions 410, 604, and 606, as shown) previously discussed are performed by control device 200 and operator 300 to ultimately form a communication connection between the two devices via command channel 608 for delivering actuation operation command 610, all while the control device 250 and operator 300 also remain connected via control channel 708.

Because, as previously discussed, the connection time via command channel 608 is relatively short (for example, 400 milliseconds) compared to the total connection time utilized for control channel 708 (for example, 10 seconds), the controller 202 of control device 200 can detect trigger event 602 and ultimately provide the associated actuation operation command 610 all while control device 250 and operator 300 are engaged in communicating auxiliary data via control channel 708. That is, the time window in which control device 200 and operator 300 communicate via command channel 608 can fall within the time window in which control device 250 and operator 300 communicate via control channel 708. Accordingly, control device 200 does not have to wait for control device's 250 communication with operator 300 via control channel 708 to terminate before establishing connection via command channel 608. In this example, those with skill in the art will understand that in connection request 604, operator 300 can request command channel 608 be established on a different one of the thirty-seven BLE channels than the BLE channel being used to for the control channel 708 so that communication via control channel 708 with control device 250 and via command channel 608 with control device 200 can be achieved simultaneously or substantially simultaneously.

Although FIG. 8 illustrates operator 300 communicating via one control channel connection 708 (with control device 250) and via one command channel connection 608 (with control device 200) simultaneously, those with skill in the art will recognize that various other examples are included in this disclosure. In some examples, operator 300 can form a connection using a control channel 708 with each of a plurality of control devices 250 simultaneously. That is, operator 300 can communicate with a plurality of control devices 250 simultaneously by using a control channel 708 with each of the plurality of control devices 250. Thus, in these examples, operator 300 can be communicating with “n” number of control devices 250 via a control channel 708 with each of the plurality of control devices 250 and receive command advertisement 410 from control device 200 while in communication with each of the plurality of control devices 250. Responsive to command advertisement 410, operator 300 can form a connection with control device 200 via command channel 608 and receive command 610 all while simultaneously communicating with each of the plurality of control devices 250 via its associated control channel 750.

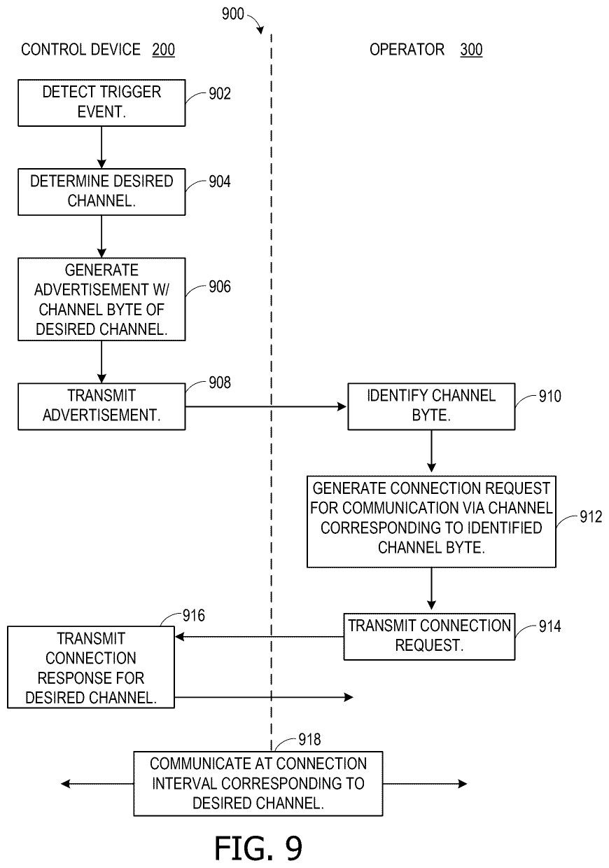

FIG. 9 is a flowchart illustrating a process 900 of selecting a virtual channel and establishing a bidirectional communication via the channel. As those with skill in the art will recognize, process 900 is utilized in performing operations 600, 700, 800 previously discussed. FIG. 9 is organized such that blocks performed illustrated to the left of the center dashed line are performed by control device 200 and blocks illustrated to the right of the center dashed line are performed by operator 300. Process 900 begins at block 902 by controller 202 detecting a trigger event, such as trigger events 602, 702 triggering communication with operator 300. Process 900 continues to block 904 where controller 202 determines which channel, command channel 608 or control channel 708, is a desired channel for establishing connection with operator 300 based on the trigger event 602, 702. After determining the desired channel, process 900 continues to block 906 where controller 202 generates an advertisement 410, 420 for establishing connection via the desired channel 608, 708. The advertisement 410, 420 includes the channel byte 414, 424 corresponding to the desired channel 608, 708. Process 900 continues to block 908 wherein controller 202 transmits advertisement 410, 420 to operator 300 via communication circuit 208.

Process 900 continues to block 910 where controller 302 receives advertisement 410, 420 via communication circuit 308. Controller 302 further identifies the channel byte 414, 424 included in advertisement 410. Process 900 continues to block 912 wherein controller 302 generates connection request 604, 704 requesting communication via the desired channel 608, 708 corresponding the channel byte 414, 424 identified in block 910. Process 900 can continue to block 914 where controller 302 transmits connection request 604, 704 to control device 200 via communication circuit 308.

Process 900 continues to block 916 where controller 202 receives connection request 604, 704 via communication circuit 208 and transmits connection response 606, 706 to operator 300. Thereby the process 900 continues to block 918 by establishing a connection via the desired channel 608, 708 between control device 200 and operator 300. The connection allows commands (such as command 610) and other data transfer between the control device 200 and operator 300, as has been described herein. After the desired data transfer is complete, communication via the desired channel 608, 708 can be terminated by control device 200 or operator 300.

Just as described in FIG. 7 discussion, although FIG. 9 illustrates control device 200 as the advertising device and operator 300 as the connecting device, according to various examples of this disclosure, operator 300 is the advertising device and control devices 200 is the connecting device. Those with skill in the art will recognize how various block blocks, such as blocks 902-908, and 916 can be performed by operator 300 in examples where operator 300 is the advertising device. Those with skill in the art will recognize how various blocks, such as blocks 910-914 are performed by control device 200 in examples where control device 200 is the connecting device.

Although FIG. 9 depicts block 902-918 being performed in a certain order, blocks 902-918 can be performed according to any of a number of orders without departing from the scope of this disclosure. Additionally, blocks or steps can be added or removed from process 900 without departing from the scope of this disclosure.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An advertising device for communication over wireless networks, comprising:
a wireless communication module; and
a processor coupled with the wireless communication module and a memory storing instructions operable by the processor to:
detect a trigger event triggering communication with a connecting device,
determine that a desired channel of a plurality of communication channels is appropriate for communication with the connecting device based on the trigger event,
generate an advertisement including a desired channel byte corresponding to the desired channel;
transmit the advertisement to the connecting device;
receive a connection request from the connecting device responsive to the advertisement, and
in response to receiving the connection request, transmit a connection response to the connecting device and thereby forming a wireless connection with the connecting device using the desired channel.

2. The advertising device of claim 1, wherein the plurality of communication channels are virtual channels defined according to a connection interval associated with each of the plurality of communication channels.

3. The advertising device of claim 1, wherein the plurality of communication channels includes:
a command channel configured operate at a first connection interval; and
a control channel configured to operate at a second connection interval slower than the first connection interval.

4. The advertising device of claim 1, wherein the connecting device is an operator operably coupled with a movable barrier and the advertising device is a control device configured to control the operator.

5. The advertising device of claim 4, wherein the memory further stores instructions operable by the processor to:
select a command channel of the plurality of communication channels for communication with the operator in response to the trigger event corresponding to providing an operational command commanding the operator to perform an operation with the movable barrier; and
select a control channel of the plurality of communication channels for communication with the operator in response to the trigger event corresponding to something other than commanding the operator to perform an operation with the movable barrier.

6. The advertising device of claim 1, wherein the desired channel byte comprises one of:
a command byte corresponding to the desired channel being a command channel; and
a control byte corresponding to the desired channel being a control channel.

7. A connecting device for communication over a wireless network, comprising:
a wireless communication module; and
a processor coupled with the wireless communication module and a memory storing instructions operable by the processor to:
receive an advertisement from an advertising device, the advertisement including a desired channel byte corresponding to a desired channel of a plurality of communication channels for communication between the connecting device and the advertising device,
identify the desired channel byte,
generate a connection request for communication with the advertising device over the desired channel corresponding to the desired channel byte,
transmit the connection request to the advertising device,
receive, from the advertising device, a connection response and thereby forming a wireless connection with the advertising device over the desired channel.

8. The connecting device of claim 7, wherein the plurality of communication channels are virtual channels defined according to a connection interval associated with each of the plurality of communication channels.

9. The connecting device of claim 7, wherein the plurality of communication channels includes:
a command channel configured operate at a first connection interval; and
a control channel configured to operate at a second connection interval slower than the first connection interval.

10. The connecting device of claim 7, wherein the desired channel byte comprises one of:
a command byte corresponding to the desired channel being a command channel; and
a control byte corresponding to the desired channel being a control channel.

11. The connecting device of claim 10, wherein the connecting device is an operator operably coupled with a movable barrier and the advertising device is a control device configured to control the operator.

12. The connecting device of claim 11, wherein:
the desired channel is a command channel used for communicating operation commands from the control device to the operator; and
the memory further stores instructions operable by the processor to:
after forming a connection with the control device over the command channel, receiving operational command commanding the operator to perform an operation with the movable barrier, and
performing the operation with the movable barrier.

13. A method for communicating over a wireless network, comprising:
detecting, by a first device, a trigger event triggering communication with a second device;
determining, by the first device, a desired channel of a plurality of communication channels appropriate for communication with the second device based on the trigger event;
generating, by the first device, an advertisement including a desired channel byte corresponding to the desired channel;
transmitting, by the first device, the advertisement;
receiving, by the second device, the advertisement;
identifying, by the second device, the desired channel byte included in the advertisement; and
in response to identifying the desired channel byte included in the advertisement, transmitting, by the second device, a connection request for establishing a communication connection with the first device via the desired channel indicated by the desired channel byte.

14. The method of claim 13, wherein:
the plurality of communication channels includes a command channel and a control channel;
the desired channel byte for the command channel comprises a command byte and the desired channel byte for the control channel comprises a control byte; and
the command channel operates using a first connection interval and the control channel operates using a second connection interval.

15. The method of claim 14, further comprising:
in response to determining that the advertisement includes the command byte, transmitting, by the second device, the connection request as a command channel connection request to the first device;
receiving, by the first device, the command channel connection request; and
transmitting, by the first device, a command channel connection response, thereby establishing a first wireless connection between the first device and the second device over the command channel at the first connection interval.

16. The method of claim 14, further comprising:
in response to determining that the advertisement includes the control byte, transmitting, by the second device, the connection request as a control channel connection request to the first device;
receiving, by the first device, the control channel connection request; and
transmitting, by the first device, a control channel connection response, thereby establishing a second wireless connection between the first device and the second device over the control channel at the second connection interval.

17. The method of claim 14, wherein the first connection interval of the command channel is a faster connection interval than the second connection interval of the control channel.

18. The method of claim 13, wherein each of the plurality of communication channels is a virtual channel defined by a connection interval associated with the communication channel.

19. The method of claim 13, wherein:
the second device is an operator coupled with and configured to control a movable barrier; and
the first device is a control device of the operator.

20. The method of claim 13, wherein:
the first device is configured to deliver operations commands for controlling operations of the second device to the second device via a command channel of the plurality of communication channels; and
the first device is configured to deliver informational data not related to controlling operations of the second device to the second device via a control channel of the plurality of communication channels.
